(19) United States
(12) Patent Application Publication
(10) Pub. No.: US 2008/0273005 A1
(43) Pub. Date: Nov. 6, 2008

(54) MIXED COLOR SEQUENTIAL CONTROLLING METHOD AND BACK LIGH MODULE AND DISPLAY DEVICE USING THE SAME

(75) Inventors: Ke-Horng Chen, Taipei County (TW); Yi-Fu Chen, Hsinchu City (TW); Tse-Chin Chen, Kaohsiung County (TW); Jion-Iou Hong, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/864,920

(22) Filed: Sep. 29, 2007

(30) Foreign Application Priority Data
May 3, 2007 (TW) 96115709

(51) Int. Cl. G02F 1/13357; G09G 3/32

(52) U.S. Cl. 345/102

(57) ABSTRACT

A mixed color controlling method for backlight module and display device using the same, in the method, a mixed color sequential (MCS) algorithm with high contrast enhancement technique is provided in RGB LED backlight display. Owing to synchronous control of LCD panel and LED backlight module, high quality image with suppressed color breakup and motion blur effects is achieved, and display contrast is improved by our novel color sequential technique. In addition, MCS algorithm is useful for color filter-less optical compensated bend (OCB) panel display for alleviating color breakup and motion blur effects.

### CROSS-REFERENCE TO RELATED APPLICATION

This application claims the priority benefit of Taiwan application serial no. 96115709, filed May 3, 2007. All disclosure of the Taiwan application is incorporated herein by reference.

### BACKGROUND OF THE INVENTION

1. Field of the Invention

The present invention relates to a driving method for a display. More particularly, the present invention relates to a driving method using a mixed color sequential algorithm for eliminating color breakup phenomenon and improving display contrast, and display device using the same.

2. Description of Related Art

With the development of the optoelectronic and semiconductor technology, there is a rapid development in the field of panel displays. Among various kinds of panel displays, the liquid crystal displays (LCDs) having the features of high space utilization efficiency, low power consumption, no radiation and low electromagnetic interference become popular in the market recently. A LCD includes a LCD panel and a backlight module. Since the LCD panel has no luminescent function itself, a backlight module is provided for providing a backlight source for the LCD panel, so as to achieve a display function of a LCD panel.

FIG. 1 is a schematic diagram of a LCD. Referring to FIG. 1, the backlight source provided by a backlight module 101 of a conventional LCD is a white light W. The backlight is transmitted to the color filter 103 on each pixel position through an electrode glass 102 to display the color of each pixel. Generally, three color filters, namely red (R) filter, green (G) filter and blue (B) filter are disposed on each pixel position to achieve a full color effect.

However, the display method of applying color filters is expensive and has a low display brightness of each pixel due to a low transmissivity of the color filters. Moreover, the adjacent areas of the three color filters, namely red filter, green filter and blue filter may have a color-mixing problem. Though a black matrix can be blocked on the adjacent areas of the three color filters for mitigating the color-mixing problem, however the transmissivity of the color filters will be further decreased.

To avoid the aforementioned low tansmissivity and color-mixing problems due to application of color filters, a color sequential LCD without color filters is provided. FIG. 2 is a schematic diagram of a color sequential LCD. Referring to FIG. 2, the colors of the backlight source provided by the backlight module 201 of the LCD are red, green and blue. According to a visual staying principle of human eyes, the three backlight source red, green and blue are switched swiftly on time axis, and human eyes may sense a mixed color effect when the backlight source is transferred to each pixel of the LCD panel 203 through the electrode glass 202.

However, for a color sequential LCD, different color fields of an object will fall on different retina points of human eyes due to the features of random saccade and instinct of tracing moving object of human eyes. Therefore, a color breakup phenomenon occurs on the edge of the object. FIG. 3 is a schematic diagram illustrating a color breakup phenomenon. Referring to FIG. 3, the backlight module of a LCD sequentially provides red, green and blue backlight sources within a frame time T to display a white block 301. When the white block 301 moves from the horizontal position X1 to X2 within the frame time T, human eyes may see non-white colors such as blue, cyan, yellow and red etc. on the edge of the white block 301.

U.S. Pat. No. 6,831,948 provides a motion compensation method for eliminating the color breakup phenomenon. However, this method needs an extra image processing procedure to accomplish the motion compensation, therefore the calculation quantity and the complexity are increased and it is difficult for implementation.

In the related arts, a method of changing the arrangement of the color sequence for eliminating the color breakup phenomenon is provided. FIGS. 4A, 4B and 4C are schematic diagrams respectively illustrating a color sequence arrangement. Referring FIG. 4A, FIG. 4A is a diagrams illustrating a conventional color sequence arrangement. The backlight module sequentially provides red, green and blue backlight sources on time axis, namely, the color sequence is R→G→B.

Japan broadcast corporation NHK provides a method of inserting a black image between each color sequence for eliminating the color breakup phenomenon. Referring to FIG. 4B, the backlight module sequentially provides red, green and blue backlight sources on time axis and inserts a black image BK, namely, the color sequence is R→G→B→BK.

U.S. Pat. No. 6,570,054 provides a color sequence upset method for eliminating the color breakup phenomenon. Referring to FIG. 4C, the backlight module sequentially provides random selected backlight source such as red, green, blue, blue, red, green, green, red backlight sources on time axis. However, the object that this method dealing with is the whole image, it is limited in mitigating the color breakup phenomenon.

### SUMMARY OF THE INVENTION

The present invention is direct to a single color sequential method for controlling the LED backlight module, by which the LED backlight module is horizontally and vertically divided into a plurality of regions. In each region, the red, green and blue backlight sources keep showing repeatedly in a cycle, or with a black inserted, the red, green, blue and black backlight sources keep showing repeatedly in a cycle. Meanwhile, the adjacent regions have different cycle modes.

The present invention is direct to a mixed color sequential method for controlling the backlight module, by which CMY gamut including cyan, magenta, and yellow are applied in this method, wherein cyan is a combination of green and blue, yellow is a combination of red and green, and magenta is a combination of red and blue. In other words, backlights of two colors are synchronously shown in each region, and the brightness is doubled accordingly, therefore the color breakup phenomenon is mitigated. Different color sequence can be set to different regions, and the cycle mode of the color sequence in the adjacent regions has to be different.

The present invention is direct to an enhanced color sequential method for controlling the backlight module. The time axis and space axis can be further extended base on the aforementioned content. For example, a high-speed frame rate may effectively reduce the chance of observing a color breakup phenomenon by human eyes. The whole image can be further subdivided into a plurality of small regions on the space axis, which may also effectively reduce the chance of observing a color breakup phenomenon by human eyes. Therefore, improvement of the frame rate and subdivision of the image may effectively mitigate the color breakup phenomenon.

In addition, the present invention further provides a mixed color sequential algorithm for controlling the backlight module. If the whole image resolution is M pixels times N scan lines, and the image is divided into x×y regions, then there are (M/x)×(N/y) pixels in each region. Next, the average gray level of each region is calculated, and the mixing ratio of backlight is calculated according to the average gray level. Therefore the display contrast can be improved by dynamically adjusting the mixing ratio of backlight on the time axis. Moreover, one of the two modes, ultra high contrast mode and high contrast mode is selected to perform the mixing ratio calculation of the backlight, according to the requirement of the image quality and cost.

The present invention provides backlights with different colors to the two adjacent regions on space axis, so as to avoid the color breakup phenomenon. Moreover, not only the display brightness can be improved by mixing colors on time axis, but also the display contrast can be improved by adjusting the mixing ratio of the backlight on the time axis according to the average gray level on each region.

In an embodiment, the present invention provides a color sequential controlling method for controlling a backlight module to provide backlights to a display panel. The color sequential controlling method includes: dividing the backlight module into a plurality of regions; dividing a frame time displayed on display panel into a plurality of sub-frame times, wherein each region provides backlight according to a corresponding color sequence within each sub-frame time to form an image corresponding to a frame, meanwhile, the corresponding color sequences of two adjacent regions are different.

According to the aforementioned color sequential controlling method, the backlight module is a light-emitting diode (LED) backlight module, and combination of the color sequence is composed of three primary colors of R, G, and B, wherein the corresponding color sequences of two adjacent regions are different. In another embodiment, the combination of the color sequence is composed of R, G, B and black which is an inserted black image.

According to the aforementioned color sequential controlling method, the backlight module is a LED backlight module, and the combination of the color sequence is composed of the CMY gamut including yellow, cyan and magenta, wherein the corresponding color sequences of two adjacent regions are different, and yellow is a combination of red and green in the LED backlight module, cyan is a combination of green and blue, and magenta is a combination of red and blue.

According to the aforementioned color sequential controlling method, when a plurality of frame data is received, each frame time of the frame data is divided into a plurality of sub-frame times, and each region repeatedly provides backlight according to a corresponding color sequence within each sub-frame time to form a plurality of images corresponding to the frame data.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram of a LCD.

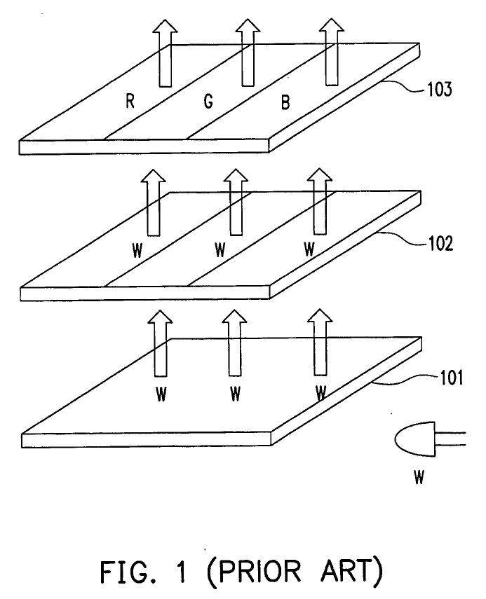

FIG. 2 is a schematic diagram of a color sequential LCD.

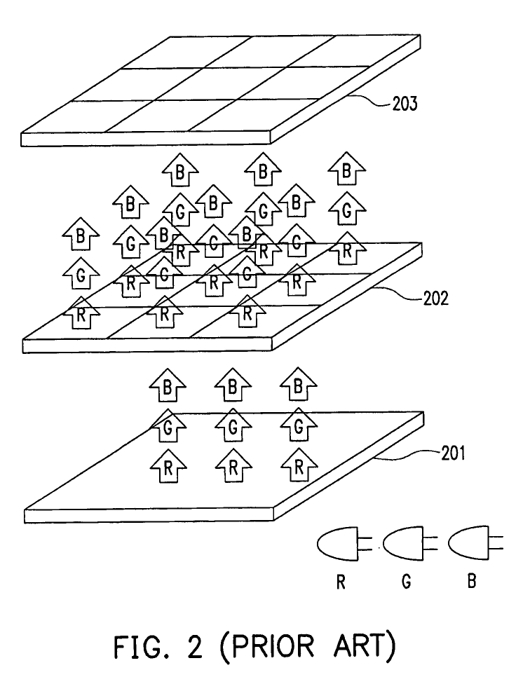

FIG. 3 is a schematic diagram illustrating a color breakup phenomenon.

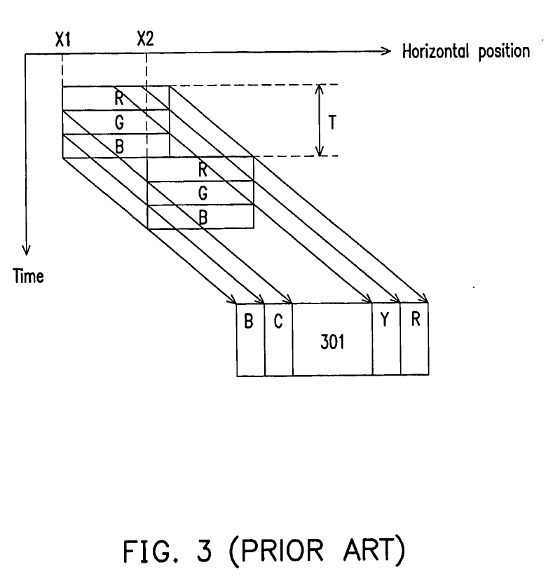

FIGS. 4A, 4B and 4C are schematic diagrams respectively illustrating a color sequence arrangement.

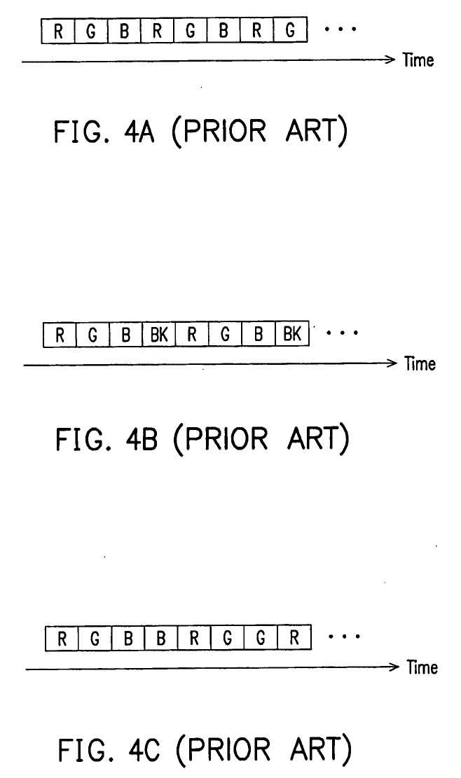

FIGS. 5A and 5B are schematic diagrams illustrating an application of a single color sequential method according to the color sequential method of the present invention for controlling the backlight module.

FIG. 6 is a schematic diagram of a color sequence according to the color sequential method of the present invention for controlling the backlight module.

FIGS. 7A and 7B are schematic diagrams of color sequence combinations according to the color sequential method of the present invention for controlling the backlight module.

FIG. 8 is a schematic diagram of a color sequence using a mixed color sequential method according to the color sequential method of the present invention for controlling the backlight module.

FIG. 9 is a schematic diagram of an enhanced color sequential method according to the color sequential method of the present invention for controlling the backlight module.

FIG. 10 is a schematic diagram of a display device using the color sequential method of the present invention for controlling the backlight module.

FIG. 11 is a schematic diagram of a LCD using the color sequential method of the present invention for controlling the backlight module of the LED.

FIG. 12 is a flowchart illustrating a mixed color sequential algorithm for controlling the backlight module according to an embodiment of the present invention.

### DESCRIPTION OF EMBODIMENTS

The present invention provides a mixed color sequential (MCS) controlling method for the backlight module and display device using the same. In this method, a mixed color sequential algorithm is provided for controlling the RGB LED back light module to generate high contrast backlight. Owing to synchronous control of LCD panel and LED backlight module, high quality images with suppressed problems of color breakup and motion blur effects are achieved and the display contrast is improved by our novel color sequential technique. In addition, MCS algorithm is useful for color filter-less optical compensated bend (OCB) panel display for alleviating color breakup and motion blur effects.

The present invention provides a driving method for a backlight module and display device using the same. The backlight module provides light source to the display panel according to the color sequential method of the present invention, in which the color breakup phenomenon is avoided by mixing colors on the space axis. In addition, not only the display brightness of the display panel can be improved by mixing colors on time axis, but also the display contrast can be improved by dynamically adjusting the mixing ratio of the backlight on the time axis.

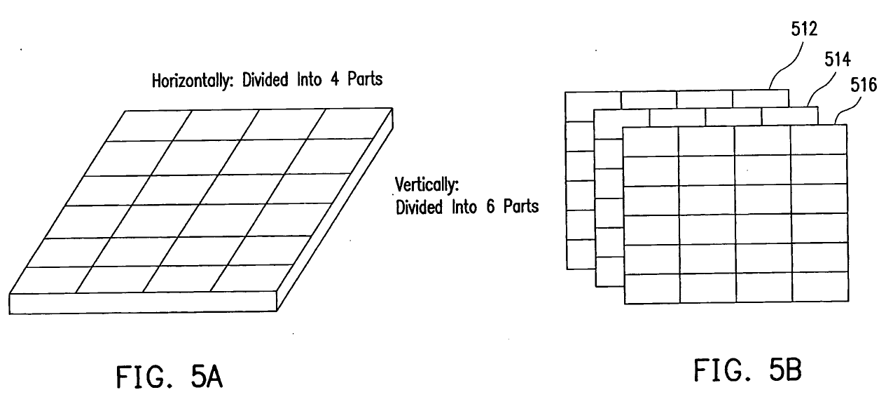

The present invention provides color sequential methods for controlling the backlight module, one of which is a single color sequential method. In the single color sequential method, a LED backlight module is horizontally and vertically divided into a plurality of small regions. In each small region, red, green and blue backlight sources keep showing repeatedly in a cycle, and the adjacent small regions have different cycle modes. Referring to FIG. 5A, assuming a complete image is divided into 4×6 regions on the space axis, deduced by analogy, images can be divided into M×N regions in accordance with the design requirement. On the time axis, the original frame rate is 60 frames per second (fps), i.e. a complete image is obtained every one to sixty second. According to the color sequential method of the present invention, the frame rate should be increased to, for example, 180 fps, each sub-frame is displayed within one to one hundred and eighty second

$$( \frac{1}{180} seconds ) ,$$

and three sub-frames are required to form a complete image, shown as sub-frames 512, 514 and 516 of FIG. 5B.

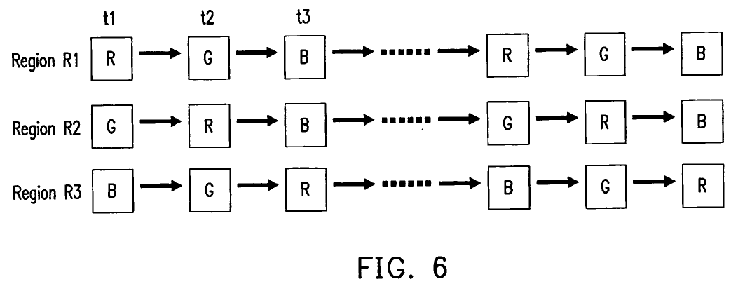

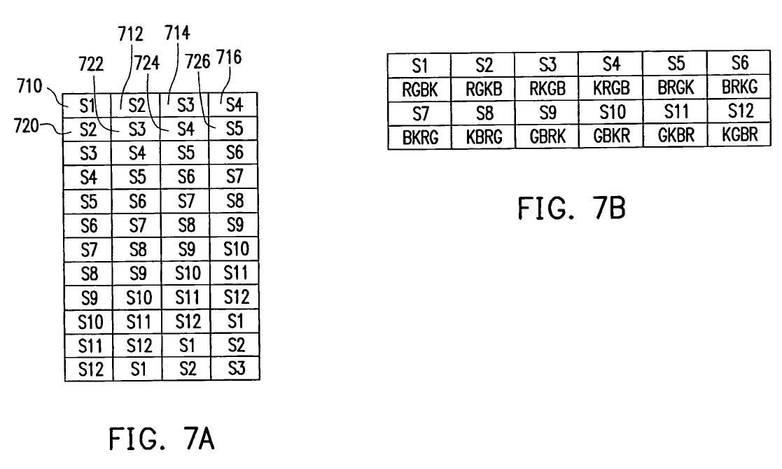

In different sub-frames, each small region sequentially changes colors according to a certain color sequence to mitigate the color breakup phenomenon. Referring to FIG. 6, though three regions R1, R2 and R3 are taken as an example, it is not limited thereto. In the regions R1, R2 and R3, colors are changed according to different color sequences, for example R→G→B, G→R→B or B→G→R. t1, t2 and t3 represent the time of the aforementioned sub-frames. FIG. 7 is a diagram illustrating that different color sequence can be set to different regions, for example, the color sequence S1, S2, S3 and S4 are respectively set to the regions 710, 712, 714 and 716 on the first row, and the color sequence S2, S3, S4 and S1 are respectively set to the regions 720, 722, 724 and 726 on the second row, and so on. Meanwhile the above arrangement method should satisfy the condition of color sequences of two adjacent regions being different from each other.

The color sequences S1˜S12 are shown in FIG. 7B. If a RGB color model and an inserted black image are applied for providing the backlight, then the color sequence S1 is RGBK, wherein R represents red, G represents green, B represents blue, and K represents a black image. Moreover, the color sequence S2 is RGKB, and S3 is RKGB etc., shown as color sequences S1˜S12 in FIG. 7B.

If there is a moving object on the image, color breakup phenomenon occurs when viewed by human eyes. However, since the adjacent regions synchronously display different colors, human eyes will misjudge a white color occurring a color breakup phenomenon. Therefore the color breakup phenomenon is mitigated. Meanwhile, the scan mode of this method simulates a pulse-driven display method of a conventional cathode ray tube television, therefore the unsatisfactory motion blur phenomenon of a LCD is mitigated accordingly.

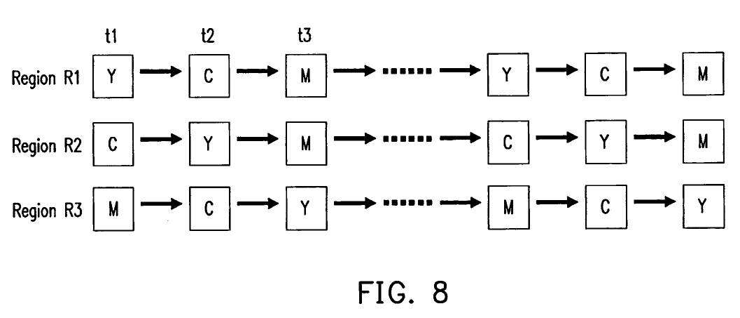

The color sequential method for controlling the backlight module can be a mixed color sequential method in another embodiment. To improve the display brightness, a mixed color sequential method is provided, and a CMY gamut comprising yellow, cyan and magenta are applied for accomplishment of the mixed sequential method. Based on a RGB LED backlight module, the yellow, cyan and magenta are respectively combinations of red and green, green and blue, red and blue. Namely, backlights of two colors are synchronously displayed in each region, and the display brightness is doubled accordingly. The color breakup phenomenon is mitigated due to only one color being missed each time on each region. The mixed color sequences are shown in FIG. 8. Different color sequences can be set to different regions, and the cycle mode of the colors in the adjacent regions should be different.

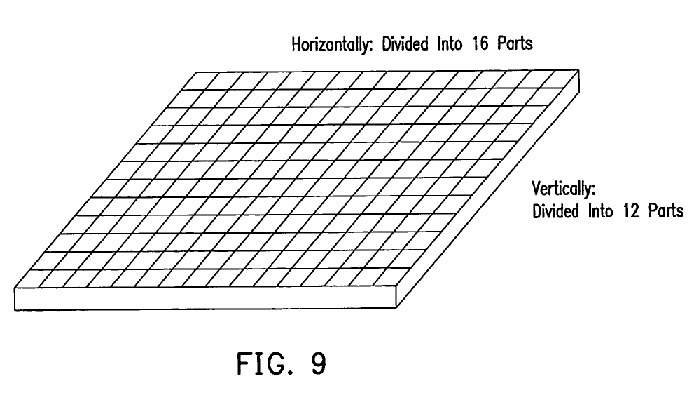

The color sequential method of the present invention for controlling the backlight module may be an enhanced color sequential method for enhancing its effect, wherein the time axis and the space axis can be further extended based on the aforementioned content. On the time axis, the frame rated is improved from 240 fps to 1440 fps or 3840 fps. A high speed frame rate may effectively reduce the chance of observing a color breakup phenomenon by human eyes. On the space axis, the whole image may be further subdivided into a plurality of small regions, for example, 16×12 regions shown as FIG. 9, which may also reduce the chance of observing a color breakup phenomenon by human eyes. Therefore, improvement of the frame rate and subdivision of the image may effectively mitigate the color breakup phenomenon.

The backlight using the aforementioned mixed color sequential method is two times brighter in brightness than that of the backlight using a single color sequential method. To improve the display contrast, a mixed color sequential algorithm is provided for a display panel having color filters by combining the aforementioned two novel color sequential methods. First, assuming the resolution of the whole image is M pixels times N scan lines, and the image is divided into x×y regions, then each small region has (M/x)×(N/y) pixels. Next, the average gray level of each region is calculated, and the mixing ratio of backlight is determined according to the average gray level. Therefore, the display contrast can be improved by dynamically adjusting the mixing ratio on the time axis.

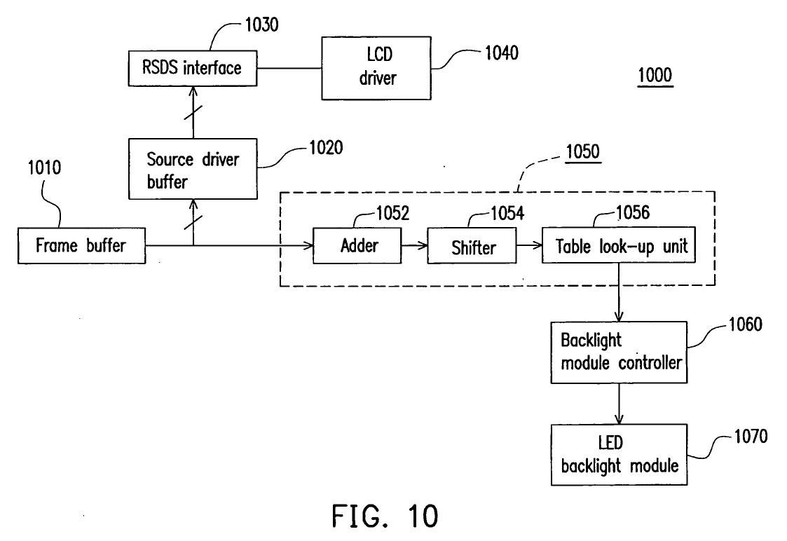

FIG. 10 is a diagram of a display device 1000 using the color sequential method of the present invention for controlling the backlight module. When the display data is transmitted to the source driver buffer 1020 from the frame buffer 1010, and is transmitted to the LCD driver 1040 from the reduced swing differential signaling (RSDS) interface 1030, the display data is synchronously transmitted to the calculator 1050. The calculator 1050 includes an adder 1052, a shifter 1054 and a table look-up unit 1056. After the calculation of the adder and multiplication/division operation of the shifter, a corresponding control signal of the backlight module can be looked up according to the display data, and the display data can be transmitted to the backlight module controller 1060 for driving the LED backlight module 1070 according to the control signal.

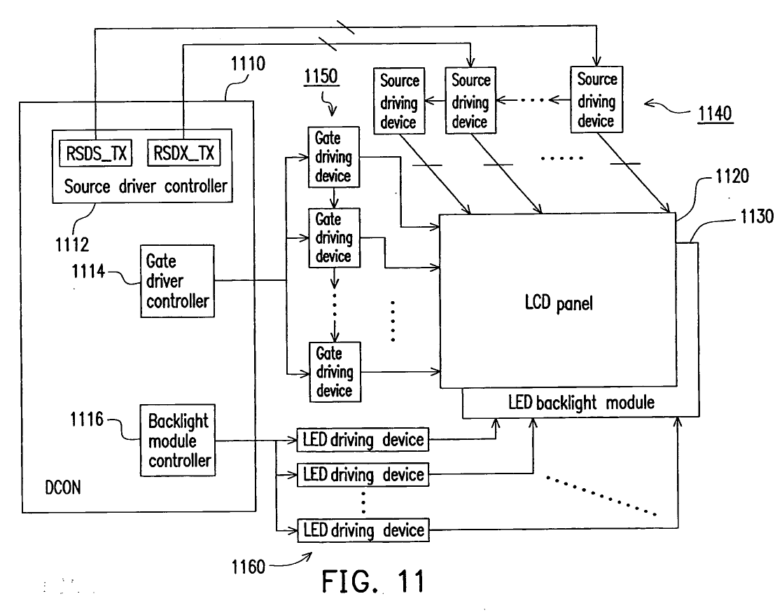

FIG. 11 is a diagram of a LCD using the color sequential method of the present invention for controlling the backlight module. The data controller (DCON) 1110 controls the LCD panel 1120 through the source driving device 1140 and the gate driving device 1150. Meanwhile, the data controller 1110 also controls the LED backlight module 1130 through the LED driving device 1160. The source driving device 1140 includes a plurality of source drivers connected to the source driver controller 1112 of the data controller 1110 through the RSDS interface. The gate driving device 1150 includes a plurality of gate drivers controlled by the gate driver controller 1114 of the data controller 1110. The LED driving device 1160 includes a plurality of LED drivers controlled by the backlight module controller 1116 of the data controller 1110. The LED driver controls the LED backlight module 1130 according to the color sequential method of the present invention.

The above embodiment with an integration of the aforementioned RGB colors model and CMY colors model provides a mixed color sequential method. This method is applied to the display panels having color filters on each region, and determines the backlight mixing ratio of each region according to the average gray level of each region, so as to improve the display brightness and contrast.

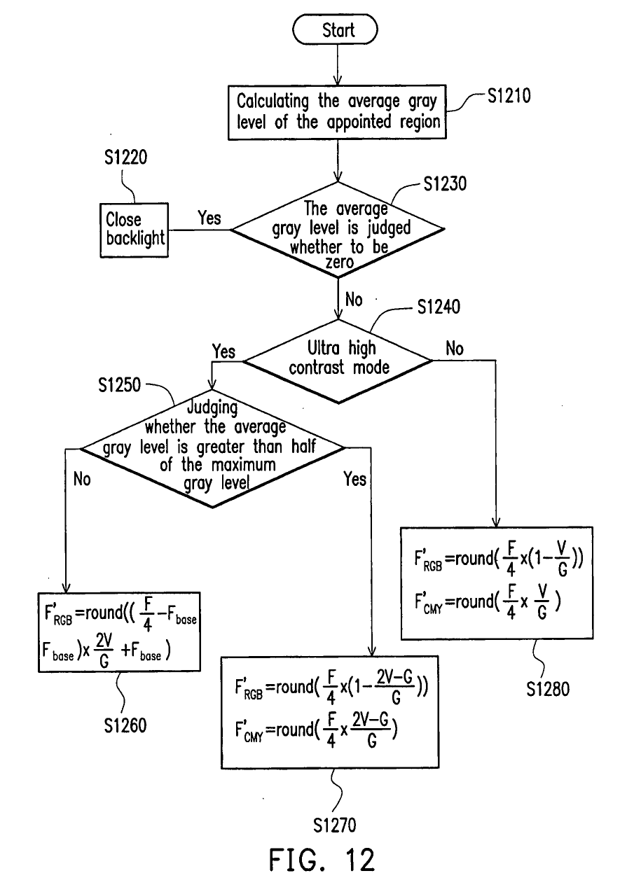

The present embodiment is still based on providing backlight with different colors on the space axis to the two adjacent regions within each sub-frame time. On the time axis, the mixing ratio of each backlight is calculated according to the average gray level of a specific region. FIG. 12 is a flowchart of a driving method of a backlight module according to an embodiment of the present invention. Assuming the display resolution is M×N, and the corresponding backlight module of the display panel is divided into X×Y regions, then each region has (M/X)×(N/Y) pixels. Referring to FIG. 12 and FIG. 11, the backlight module controller calculates the average gray level V_{Z} of an appointed region Z (step S1210), and determines the backlight mixing ratio of the appointed region Z. For example, the average gray level of the appointed region Z is

$${V}_{Z} = ( {\sum }_{a = 1}^{N / Y} {\sum }_{a = 1}^{M / X} P a ) / ( M N / X Y ) ,$$

wherein Pa is the gray level of each pixel in the appointed region Z.

Next, the average gray level V_{Z} is judged whether to be zero (step 1230). If the average gray level V_{Z} is zero, the backlight module is controlled to close the backlight of the appointed region Z (step S1220). If the average gray level V_{Z} is not zero, one of the two modes, ultra high contrast mode and high contrast mode is selected to perform the mixing ratio calculation of the backlight (step S1240), wherein the two modes are obtained from deduction of experimental simulation.

In the ultra high contrast mode, half of the maximum gray level G is taken as a reference value for calculation (step S1250). For example, a pixel is represented by 8 bits, then the maximum gray level G is 255. If the average gray level V_{Z}≦G/2, then the first frame number F′_{RGB} of the backlight of RGB colors model is calculated according to the mixed color sequential algorithm (step 1260). If the first frame number F′_{RGB} is less than a frame rate F (fps), the backlight module provides backlight to the appointed region Z by means of combining the RGB colors model with the black image, wherein the number of inserted black image is frame rate F minus first frame number F′_{RGB}.

For example, assuming the frame rate F is 64 sub-frames displayed within every 60 Hz, the maximum gray level G is 255, and the backlight module 502 may provide four-color backlights red (R), green (G), blue (B) and black (K). Then four-color sub-frames are required for completing a frame (or image) on the appointed region Z. According to the above assumption, 64/4=16 sets frames should be displayed within every 60 Hz, wherein each set is the sequence of R, G, B and K.

If V_{Z}=80(≦G/2), then the first frame number

$${F}_{RGB}^{′} = round ( ( \frac{F}{4} - {F}_{base} ) \times \frac{2 {V}_{Z}}{G} + {F}_{base} ) ,$$

wherein F_{base} is the basic frame number, and round( ) is complied with a rounding operation. Assuming F_{base}=2, which is a preferable value obtained from experimentation, and represents at least two sets of frames with backlight displayed in accordance with RGBK sequences should be displayed. By calculation, the first frame number F′_{RGB}=9, which represents 9 sets (36 sub-frames) of frames with backlight displayed in accordance with RGBK sequences should be displayed and 7 sets (28 sub-frames) of black images should be inserted within every 60 Hz.

Moreover, in the ultra high contrast mode, if the average gray level V_{Z}≧G/2, the first frame number F′_{RGB} of the backlight of RGB colors model and the second frame number F′_{CMY} of the backlight of CMY colors model are calculated according to the mixed color sequential algorithm (step S1270). Therefore, the backlight module provides backlight source to the appointed region Z by a mixed means of the backlight of RGB colors model and the backlight of CMY colors model.

For example, same as above assumption, F=64, G=255, and the backlight module 502 may provide four-color backlights RGBK. If V_{Z}=200(≧G/2), then the first frame number

$${F}_{RGB}^{′} = round ( \frac{F}{4} \times ( 1 - \frac{2 {V}_{Z} - G}{G} ) ) ,$$

and the second frame number

$${F}_{CMY}^{′} = round ( \frac{F}{4} \times \frac{2 {V}_{Z} - G}{G} ) .$$

By calculation, the first frame number F′_{RGB}=7, and the second frame number F′_{CMY}=9, which represents 7 sets (28 sub-frames) of frames with backlight displayed in accordance with RGBK sequences should be displayed and 9 sets (36 sub-frames) of frames with backlight displayed in accordance with CMYK sequences should be displayed within every 60 Hz.

In the high contrast mode, the first frame number F′_{RGB} of the backlight of RGB colors model and the second frame number F′_{CMY} of the backlight of CMY colors model are calculated according to the mixed color sequential algorithm (step S1280). Therefore, the backlight module provides backlight source to the appointed region Z by a mixed means of the backlight of RGB colors model and the backlight of CMY colors model.

For example, same as above assumption, F=64, G=255, and the backlight module 502 may provide four-color backlights RGBK. If V_{Z}=80(≦G/2), then the first frame number

$${F}_{RGB}^{′} = round ( \frac{F}{4} \times ( 1 - \frac{{V}_{Z}}{G} ) ) ,$$

and the second frame number

$${F}_{CMY}^{′} = round ( \frac{F}{4} \times \frac{{V}_{Z}}{G} ) .$$

By calculation, the first frame number F′_{RGB}=5, and the second frame number F′_{CMY}=11, which represents 5 sets (20 sub-frames) of frames with backlight displayed in accordance with RGBK sequences should be displayed and 11 sets (44 sub-frames) of frames with backlight displayed in accordance with CMYK sequences should be displayed within every 60 Hz. If V_{Z}=200(≧G/2), by calculation, the first frame number F′_{RGB}=3, and the second frame number F′_{CMY}=13, which represents 3 sets (12 sub-frames) of frames with backlight displayed in accordance with RGBK sequences should be displayed, and 13 sets (52 sub-frames) of frames with backlight displayed in accordance with CMYK sequences should be displayed within every 60 Hz.

In summary, the present invention provides a driving method of backlight module and display device using the same. The backlight module provides light source to the display panel according to the color sequential method of the present invention. In this method, the color breakup phenomenon is avoided by mixing colors on the space axis. Moreover, not only the display brightness of the display panel can be improved by mixing colors on time axis, but also the display contrast can be improved by dynamically adjusting the mixing ratio of the backlight on the time axis.

The present invention provides a single color sequential method for controlling the LED backlight module, by which the LED backlight module is horizontally and vertically divided into a plurality of small regions. In each small region, the red, green and blue backlight sources keep showing repeatedly in a cycle, or with a black inserted, the red, green, blue and black backlight sources keep showing repeatedly in a cycle. However, the adjacent regions have different cycle modes. This is what we called single color sequential method.

The present invention provides a mixed color sequential method for controlling the backlight module, by which CMY gamut including cyan, magenta, and yellow are applied in this method, wherein cyan is a combination of green and blue, magenta is a combination of red and blue, and yellow is a combination of red and green. In other words, backlights of two colors are synchronously displayed in each region, and the display brightness is doubled accordingly, therefore the color breakup phenomenon is mitigated. Different color sequence can be set to different regions, and the cycle mode of the colors in the adjacent regions should be different.

The present invention provides an enhanced color sequential method for controlling the backlight module. The time axis and space axis can be further extended base on the aforementioned content. For example, a high-speed frame rate may effectively reduce the chance of observing a color breakup phenomenon by human eyes. The whole image can be further subdivided into a plurality of small regions on the space axis, which may also effectively reduce the chance of observing a color breakup phenomenon by human eyes. Therefore, improvement of the frame rate and subdivision of the image may effectively mitigate the color breakup phenomenon.

In addition, the present invention further provides a mixed color sequential algorithm for controlling the backlight module. Assuming the image resolution is M pixels times N scan lines, and the image is divided into x×y regions, then there are (M/x)×(N/y) pixels in each region. Next, the average gray level of each region is calculated, and the mixing ratio of backlight is determined according to the average gray level. Therefore the display contrast can be improved by dynamically adjusting the mixing ratio on the time axis. Moreover, one of the two modes, ultra high contrast mode and high contrast mode is selected to perform the mixing ratio calculation of the backlight, according to the requirement of the image quality and cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color sequential controlling method for controlling a backlight module to provide backlight to a display panel, the color sequential controlling method comprising:
dividing the backlight module into a plurality of regions; and
dividing a frame time displayed on the display panel into a plurality of sub-frame times, each region providing backlights according to a corresponding color sequence within the sub-frame times to form a image corresponding to a frame, wherein the two adjacent regions have different corresponding color sequences.

2. The color sequential controlling method as claimed in claim 1, wherein the backlight module is a LED backlight module, the color sequence is composed of three primary colors of red, green, and blue, and the two adjacent regions have different corresponding color sequences.

3. The color sequential controlling method as claimed in claim 1, wherein the backlight module is a LED backlight module, the color sequence is composed of red, green, blue and black which is an inserted black image, and the two adjacent regions have different corresponding color sequences.

4. The color sequential controlling method as claimed in claim 1, wherein the backlight module is a LED backlight module, the color sequence is composed of CMY gamut including yellow, cyan and magenta, and the two adjacent regions have different corresponding color sequences.

5. The color sequential controlling method as claimed in claim 4, wherein the yellow is a combination of red and green in the LED backlight module, the cyan is a combination of green and blue, and the magenta is a combination of red and blue.

6. The color sequential controlling method as claimed in claim 2, wherein when a plurality of frame data is received, each frame time of the frame data is divided into a plurality of sub-frame times, and each region repeatedly provides backlights according to the corresponding color sequence within each sub-frame time to form a plurality of images corresponding to the frame data.

7. The color sequential controlling method as claimed in claim 1, wherein the color sequence is obtained by calculation according to a mixed color sequential algorithm, the calculation comprises:
calculating an average gray level of each of the regions; and
determining mixing ratios of a first gamut and a second gamut within the different sub-frame times on the appointed region according to the average gray level to generate a corresponding backlight.

8. The color sequential controlling method as claimed in claim 7, wherein the mixing ratio is determined by, if the average gray level is not zero, the corresponding frame number of the first gamut and the second gamut is calculated according to a mixed color sequential algorithm to obtain the mixing ratio of the first gamut and the second gamut.

9. The color sequential controlling method as claimed in claim 7, wherein the first gamut is three primary colors of red, green and blue of the LED backlight module, and the mixing ratio is determined by, if the average gray level is not zero, a first frame number of a first RGB gamut is calculated according to a mixed color sequential method, and if the first frame number is less than a frame rate, a black image is inserted, and the number of inserted black image is the frame rate minus the first frame number.

10. The color sequential controlling method as claimed in claim 9, wherein the step of determining the mixing ratio within different sub-frame times on the appointed region according to the average gray level further comprises calculating a second frame number of a CMY gamut according to the mixed color sequential algorithm.

11. A display device, comprising:
a display panel;
a backlight module, divided into a plurality of regions respectively providing backlight to the display panel; and
a backlight controller, coupled to the backlight module, for receiving a frame data, configured to divide a frame time displayed on the display panel into a plurality of sub-frame times, each region of the backlight module providing backlights according to a corresponding color sequence within the sub-frame times to form images corresponding to the frame data on the display panel, wherein the two adjacent regions of the backlight module have different corresponding color sequences.

12. The display device as claimed in claim 11, wherein the backlight module is a LED backlight module, the color sequence is composed of three primary colors of red, green, and blue, and the two adjacent regions have different corresponding color sequences.

13. The display device as claimed in claim 11, wherein the backlight module is a LED backlight module, the color sequence is composed of red, green, blue and black which is an inserted black image, and the two adjacent regions have different corresponding color sequences.

14. The display device as claimed in claim 11, wherein the backlight module is a LED backlight module, the color sequence is composed of CMY gamut including yellow, cyan and magenta, and the two adjacent regions have different corresponding color sequences.

15. The display device as claimed in claim 14, wherein the yellow is a combination of red and green in the LED backlight module, the cyan is a combination of green and blue, and the magenta is a combination of red and blue.

16. The display device as claimed in claim 11, wherein when a plurality of frame data is received, each frame time of the frame data is divided into a plurality of sub-frame times, and each region repeatedly provides backlights according to the corresponding color sequence within each sub-frame time to form a plurality of images corresponding to the frame data.

17. The display device as claimed in claim 11, wherein the color sequence is obtained by calculation according to a mixed color sequential algorithm, the calculation comprises:
calculating an average gray level of each region; and
determining mixing ratios of a first gamut and a second gamut within the different sub-frame times on the appointed region according to the average gray level to generate a corresponding backlight.

18. A backlight module controlling method, comprising:
dividing a backlight module into a plurality of regions; and
receiving a frame data, dividing a frame time of the frame data into a plurality of sub-frame times, each region of the backlight module providing backlights according to a corresponding color sequence within the sub-frame times to form images corresponding to the frame data on the display panel, wherein the two adjacent regions of the backlight module have different corresponding color sequences.

19. The backlight module controlling method as claimed in claim 18, wherein the backlight module is a LED backlight module, the color sequence is composed of three primary colors of red, green, and blue, and the two adjacent regions have different corresponding color sequences.

20. The backlight module controlling method as claimed in claim 18, wherein the backlight module is a LED backlight module, the color sequence is composed of red, green, blue and black which is an inserted black image, and the two adjacent regions have different corresponding color sequences.

21. The backlight module controlling method as claimed in claim 18, wherein the backlight module is a LED backlight module, the color sequence is composed of CMY gamut including yellow, cyan and magenta, and the two adjacent regions have different corresponding color sequences.

22. The backlight module controlling method as claimed in claim 21, wherein the yellow is a combination of red and green in the LED backlight module, the cyan is a combination of green and blue, and the magenta is a combination of red and blue.

23. The backlight module controlling method as claimed in claim 18, wherein when a plurality of frame data is received, each frame time of the frame data is divided into a plurality of sub-frame times, and each region repeatedly provides backlights according to the corresponding color sequence within each sub-frame time to form a plurality of images corresponding to the frame data.

24. The backlight module controlling method as claimed in claim 18, wherein the color sequence is obtained by calculation according to a mixed color sequential algorithm, the calculation comprises:
calculating an average gray level of each region; and
determining mixing ratios of a first gamut and a second gamut within the different sub-frame times on the appointed region according to the average gray level to generate a corresponding backlight.
